(19) United States
(12) Patent Application Publication
(10) Pub. No.: US 2005/0252969 A1
(43) Pub. Date: Nov. 17, 2005

(54) Card reader for electronic device

(75) Inventor: Mei-Ching Wu, Taipei (TW)

Correspondence Address: EITAN, PEARL, LATZER & COHEN ZEDEK LLP, 10 ROCKEFELLER PLAZA, SUITE 1001, NEW YORK, NY, 10020, US

(73) Assignee: INVENTEC CORPORATION

(21) Appl. No.: 11/023,507

(22) Filed: Dec. 29, 2004

(30) Foreign Application Priority Data
May 14, 2004 (TW) 093207539

(51) Int. Cl. G06K 7/06

(52) U.S. Cl. 235/441

(57) ABSTRACT

A card reader for electronic devices comprises: a main body at least having a printed circuit board (PCB), a plurality of first and second slots arranged in a front portion of the main body, and a connector connected to the main body for outputting the data converted by the PCB. Data of a storage medium inserted into the first or second slot is converted and outputted to an electronic device, thus expanding the functions of the electronic device and upgrading data storage capacity and speed.

### FIELD OF THE INVENTION

The present invention relates generally to a card reader, and more particularly, to a card reader connected to an electronic device for expanding the function thereof.

### BACKGROUND OF THE INVENTION

With the development of science and technology, human life is made easier and more convenient. Electronic devices, such as electronic dictionaries, electronic translators, digital cameras and so on, are frequently used. They can be connected to computers for use. Digital cameras, as an example, convert captured images into digital data, and store the data to a storage media such as a memory card, instead of films where images are developed from in conventional cameras. In addition, the digital camera can be connected to a computer to transmit digital data thereto for editing, storing, or printing.

Further, the continuously developed fabricating technology of integrated circuit makes the storage capacity of a memory card increasingly larger; and the size of the memory card increasingly smaller. Flash memory, for example, which does not need power for keeping the storage of data, is widely employed in fabricating storage device of memory card for its characteristics of small size and large capacity. Various memory cards presently provided in the market, for example, CF (compact flash) card, Microdrive (MC) card, SM (smart media) card, MMC (multimedia card), SD (secure digital) card, and MS (memory stick) card; and the later XD picture card, CUD (compact U disk) and so on, have advantages of small size, portability, large capacity and so on.

However, usually the aforementioned memory cards cannot be directly connect to a computer for transmitting data, but have to be connected via an adapter. There are various kinds and standards of adapters currently provided in the market. Consumer must choose an adapter having the same standard as the memory card in order to successfully connect the memory card to the computer for data access. In the case of the memory card is used in a different computer, it would be very inconvenient for the consumer if the standard of the adapter is not compatible, or the adapter is not available.

A simple method to solve the problem of a single standard adapter not compatible with multiple memory card standards is to integrate all of the present standards into a single adapter, and the card is connected to computer or other peripheral device via a USB interface. Thus, said adapter is compatible with various memory cards, solving the problem of a single standard not compatible with other standards.

However, generally memory cards are provided to a particular peripheral device such as a digital camera for storing data. They are limited by the type of devices and cannot be arbitrarily employed in other peripheral devices for storage or reading. Thus the application flexibility is poor, and cannot provide a wider application range.

With the maturity of fabricating technology of memory chips, the memory capacity of a memory chip is almost as high as a small hard disk drive. The memory chip becomes a portable disk with small size and large capacity. The memory chip is commercially known as a “pen drive” (hereafter the memory chip is referred to as pen drive). Such portable pen drive is not only small in size, but can also be integrated with a USB connector, which enables direct connection between the pen drive and a computer or other output devices without using an adapter. Pen drives now offer another choice of portable storage medium, besides CF card, SM card, MD card, MMC, SD card and MS card. Compared with the above memory cards, pen drive does not require extra power or driver software, thus a user can easily store data into the pen drive for facilitating further data storage to another electronic device.

Pen drive has the advantages of small size, high capacity, speediness, high compatibility, robustness (compared with conventional hard disk drive), and low cost. In addition, pen drive incorporating USB connector complies with the plug-and-play standard and does not require built-in power. It can directly transmit data to the computer or relating devices. Pen drive also has the advantages of high security, high transmission rate, easy to operate, and requires no practice in computer assembly or changes of the computer equipment. It is applicable in operating systems such as Windows 98, Windows 2000, Windows XP and Mac OS 8.6. Thus, pen drive is becoming widely used by consumers.

However, the number of input/output (I/O) interfaces of a conventional computer is predefined, for example, only one USB interface is provided. The present peripheral devices of a computer, such as printer, scanner and the like, usually employ USB interfaces. Although USB interface can connect to as many as 127 sets of peripheral devices in series, conventional computer peripheral devices are not configured to provide said series connection interfaces, thus the limited number of USB interfaces of a computer can not satisfy the demands. In addition, if an adapter is also used, more USB interfaces are required. Conventional method of increasing the number of USB interfaces is to plug USB interface cards into the expansion slots of a motherboard, or employ a USB hub. It is easy to realize the above methods for a desktop computer. However, in the case of a notebook computer, the USB interface card cannot be plugged in, so only the USB hub can be employed. Therefore, peripheral devices for the notebook computer are increased, which causes inconvenience and encumbrance for users when carrying.

Moreover, if the above electronic devices are restructured in order to increase the number of interface ports, it will present challenges to the fabrication process and cost, and the price of the product may need to be raised. Thus, benefits of both of manufacturers and consumers will be reduced. Consequently, the conventional technology needs to be improved.

### SUMMARY OF THE INVENTION

To overcome the above drawbacks of the conventional technology, the primary objective of the present invention is to provide a card reader for electronic devices for expanding functions and increasing data transmitting capacity and speed thereof.

Another objective of the present invention is to provide a card reader that can be widely used in various electronic devices without restructuring the electronic devices.

In accordance with the above and other objectives, the present invention proposes a card reader for an electronic device comprising: a main body, a plurality of first slots, at least a second slot, and a connector. The main body comprises a printed circuit board (PCB). The plurality of first slots are arranged in a front portion of the main body for correspondingly receiving a plurality of first storage media, so that the first storage media are able to convert data via the PCB. The one or more second slots are also arranged at the front portion of the main body for correspondingly receiving one or more second storage media, so that the one or more second storage media are able to convert data via the PCB. The connector is connected to the main body for outputting the data converted by the PCB. In a preferred embodiment of the present invention, the main body is electrically connected, and integrally arranged in the electronic device, such as a desktop computer or a notebook computer. Each of the first slots comprises a first signal connector for receiving and electrically connecting the first storage medium to the electronic device. Each of the one or more second slots comprises a second signal connector for receiving and electrically connecting the received second storage medium to the electronic device. Therefore, the electronic device can read or store data of the first or second storage media without having to additionally increase connecting ports, thus facilitating access to the storage media.

Further, the second storage media received in the second slot is prevented from being exposed in the outer environment, thus avoiding damage or data lost.

### BRIEF DESCRIPTION OF THE DRAWINGS

The drawings included herein provide a further understanding of the invention. A brief description of the drawings is as follows:

FIG. 1 is a schematic front view of a card reader for an electronic device in accordance with the present invention;

FIG. 2 is a schematic top view of a built-in card reader for the electronic device in accordance with the present invention;

FIG. 3 is a three-dimensional view of the built-in card reader for the electronic device in accordance with the present invention;

FIG. 4 is a schematic top view of an external plug-in card reader for another electronic device in accordance with the present invention; and

FIG. 5 is a three-dimensional view of the external plug-in card reader for the electronic device in accordance with the present invention.

### DETAILED DESCRIPTION OF THE PREFERRED EMBODIMENT

First Preferred Embodiment

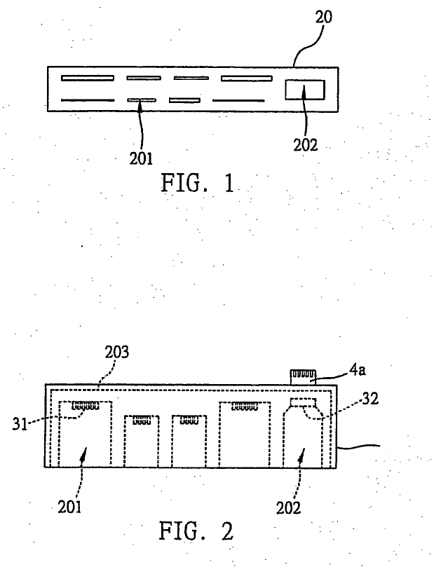

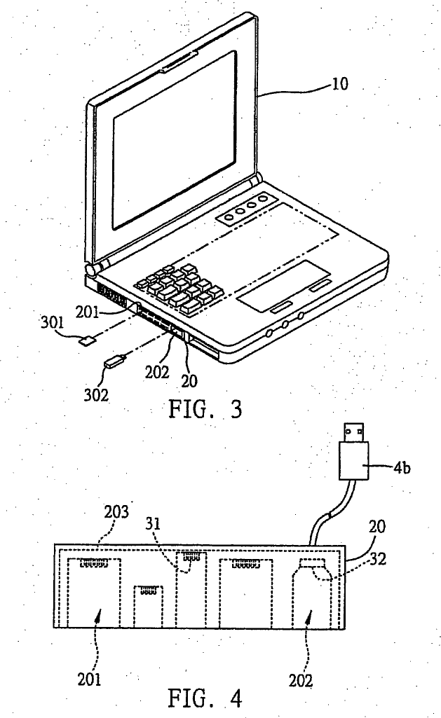

Referring to FIGS. 1-3, a main body 20 in accordance with the present invention provides electrically connection to an electronic device 10, such as a notebook computer, a laptop computer, a portable computer, or a desktop computer. The main body 20 comprises a plurality of first slots 201 and second slots 202 in a front portion thereof, as illustrated in FIG. 1. Each of the first slots 201 and second slots 202 respectively comprises a first and a second signal connector 31, 32. The main body 20 comprises a printed circuit board (PCB) 203. The first and second signal connectors 31, 32 allow storage media (detailed will be described below) inserted in the first and second slots 201, 202 to electrically connect to the electronic device 10 via interfaces (not shown) integrated in the PCB 203. The first and second signal connectors 31, 32 can alternatively integrally connect to an inner connector 4a, as illustrated in FIG. 2, to couple the main body 20 to the electronic device 10 in a built-in manner, as illustrated in FIG. 3, via the inner connector 4a electrically connected to the electronic device 10.

Further, the first signal connector 31 of each of the first slots 201 is selected from standards which comply with the PCMCIA (Personal Computer Memory Card International Association) standards, such as CF, SM, MMC, SD, MS, XD or CUD, to receive various kinds of first storage media 301, such as CF cards, SM cards, MMC, SD cards, MS cards, XD cards, or CUD, thus the electronic device 10 connects with said various first storage media 301 for data access.

The second signal connector 32 of the second slot 202 is selected to comply with USB standard, to receive a second storage media 302, such as a pen drive, thus the electronic device 10 connects with said various second storage medias 302 for data access.

Because the main body 20 comprises the first slot 201 and second slot 202 in the front portion thereof; and the first and second slots 201, 202 respectively comprises first and second signal connectors 31, 32 complying with different standards. Thus, various kinds of first storage medium 301 and second storage medium 302 can be inserted to connect to the electronic device 10. Therefore, the card reader comprises connecting ports of various standards to connect with various storage media. The application flexibility of the card reader can be greatly improved. In the case of the first and second signal connectors 31, 32 are integrally connected to the inner connector 4a, the first and second signal connectors 31, 32 can be directly connected to an expansion slot of a motherboard (not shown). Such built-in connection means save the connecting ports of the electronic device 10 for other peripheral devices.

The second slot 202 is configured to receive different brands of second storage media 302 (such as pen drive). Therefore, size of the second slot 202 is bigger than that of the second storage media 302 for receiving said second storage media 302 therein. For facilitating the second storage media 302 to be smoothly inserted into the second signal connector 32 of the second slot 202, the end portion of the second slot 202 is filter-shaped. Therefore the second storage media 302 can be easily inserted into the second signal connector 32 at the end of the second slot 202.

Alternatively, the configuration of the second storage media 302 can be designed to correspond to the shape of the second slot 202, so as to enable the second storage media 302 to be precisely fitted into the second signal connector 32 and the second slot 202. This embodiment is application specific.

While the card reader of the present invention has been shown in a built-in manner, the card reader should not be limited by the above embodiment, for example, the card reader may also be implemented in an external plug-in type.

Second Preferred Embodiment

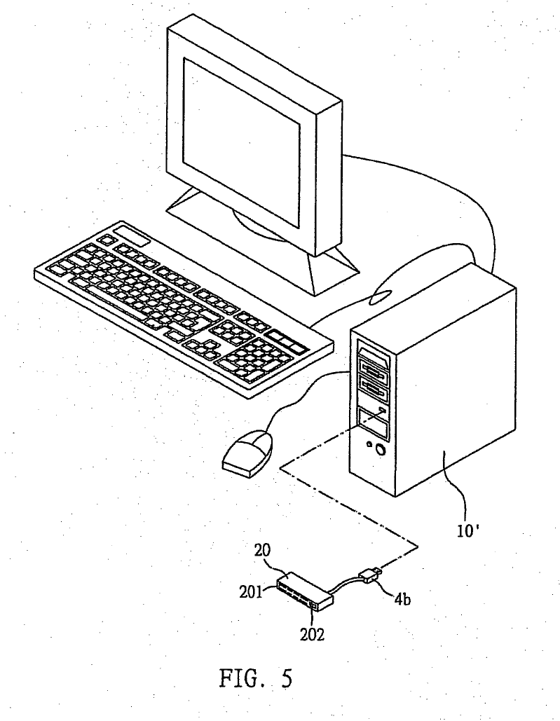

Referring to FIGS. 4 and 5, as illustrated in FIG. 4, the main body 20 of the present invention is connected to an electronic device 10′ via an outer connector 4b in an external plug-in manner. The first and second signal connectors 31, 32 in the first and second slots 201, 202 are integrally connected to the outer connector 4b. As illustrated in FIG. 5, the present embodiment is different from the previous embodiment in that: the main body 20 is connected to the electronic device 10′ in an external plug-in manner via the outer connector 4b, thus the electronic device 10′ that is unable to adopt a built-in manner can employ the card reader of the present invention in an external plug-in manner.

Accordingly, the card reader of the present invention can be coupled to an electronic device, such as notebook computer, in a built-in manner (for example, via an inner connector); or to a desktop computer, in an external plug-in manner (for example, via an external connector). The functionalities of electronic devices can be expanded and the data accessing speed and size can be increased due to the disposal of storage medium via the card read of the present invention. The card read proposed by the present invention can also be widely applied to existing electronic products without the need to redesign the current structures thereof.

It should be apparent to those skilled in the art that the above description is only illustrative of specific embodiments and examples of the invention. The invention should therefore cover various modifications and variations made to the herein-described structures and operations of the invention, provided they fall within the scope of the invention as defined in the following appended claims.

1. A card reader for an electronic device comprising:
a main body comprising a printed circuit board (PCB);
a plurality of first slots arranged in a front portion of the main body for correspondingly receiving a plurality of first storage media, the first storage media converting data via the PCB;
at least a second slot arranged at the front portion of the main body for correspondingly receiving at least a second storage medium, the second storage medium converting data via the PCB; and
a connector connected to the main body for outputting the data converted by the PCB.

2. The card reader for electronic device as claimed in claim 1, wherein each of the first slots comprises a first signal connector for receiving the first storage medium in the first slot.

3. The card reader for electronic device as claimed in claim 2, wherein first signal connector complies with one standard selected from the group consisting of CF (compact flash), SM (Smart Media), MMC (Multimedia card), SD (Secure Digital), MS (Memory Stick), XD (XD Picture card), and CUD (Compact U Disk).

4. The card reader for electronic device as claimed in claim 1, wherein the first storage media is one selected from the group consisting of CF card, SM card, MMC, SD card, MS card, XD card, and CUD.

5. The card reader for electronic device as claimed in claim 1, wherein each of the at least one second slot comprises a second signal connector for receiving the second storage media in the second slot.

6. The card reader for electronic device as claimed in claim 5, wherein the second signal connector complies with the USB (Universal Serial Bus) standard.

7. The card reader for electronic device as claimed in claim 1, wherein the second storage media is a pen drive.

8. The card reader for electronic device as claimed in claim 1, wherein the connector is an inner connector.

9. The card reader for electronic device as claimed in claim 1, wherein the connector is an external connector.

10. The card reader for electronic device as claimed in claim 1, wherein the electronic device is one selected from the group consisting of a notebook computer, a laptop computer, a portable computer and a desktop computer.
